(19) United States
(12) Patent Application Publication
(10) Pub. No.: US 2015/0216023 A1
(43) Pub. Date: Jul. 30, 2015

(54) ELECTRONIC DEVICE FOR CONTROLLING AND POWERING DISCHARGE LAMPS

(71) Applicants: Pascal Maillach, Auffay (FR); Philippe Fontenoy, Lemps (FR)

(72) Inventors: Pascal Maillach, Auffay (FR); Philippe Fontenoy, Lemps (FR)

(73) Assignee: AITHER-LIGHTING SAS

(21) Appl. No.: 14/424,531

(22) PCT Filed: Aug. 29, 2012
(86) PCT No.: PCT/FR2012/051954

§ 371 Date: Mar. 30, 2015

(51) Int. Cl. H05B 41/36; H05B 37/02

(52) U.S. Cl. CPC H05B 41/36; H05B 37/0218; H05B 37/0227

(57) ABSTRACT

Electronic device (1) to control and power discharge lamps (320) comprising:
one power signal generator (2);
a number of dedicated control units (3), each one dedicated to the control of at least one discharge lamp (320).

According to this device, the control units (3) are connected in parallel by a single power bus (41) to the said generator (2) and, for each of the lamps (320) to which the units are dedicated, each of the control units comprises an electronic circuit (32) connected to the said lamp (320) and to the power bus (41) and comprises a resonance means (322, 328) capable of resonating at a power-supply signal frequency in such a way as to create an over-voltage at the terminals of the said discharge lamp (320) and so trigger its illumination.

The present invention is a device which powers, monitors and controls discharge lamps including, among others, fluorescent tubes or lamps organized into lighting segments.

The device is used, for example, with discharge lamps to provide ambient lighting of buildings with large surface area and aims to improve energy efficiency and increase the functionality of control lamps using a relatively simple electrical installation or an existing installation.

The envelopes of discharge lamps are permeable by light-rays and contain a gas which can, by ionization, become a conductor and emit light radiation. Discharge lamps include electrodes, with or without filaments, which emit electrons when they are subjected to an electric current.

Discharge lamps include, among other things, fluorescent lamps, neon lamps, sodium vapor lamps, mercury vapor lamps, and metal halide lamps.

By their intrinsic nature, discharge lamps cannot be powered directly from a line voltage. The lamp ionization requires conduction between the electrodes at a much higher potential difference than the voltage available on the mains. In addition, the negative impedance of the ionized medium would cause an overload which could destroy the lamp.

In current technologies, discharge lamps such as, for example, a fluorescent lamp, include a device called a “ballast”, in its power circuit, which ensures ignition and, when the lamp is lit, limits the current to an acceptable level in order to avoid damage to the lamp. Two technologies are used to achieve this ballast. The first technology, called “ferromagnetic,” is based on a fundamental and historical technique. The other, more recent and more technically-advanced, is called “electronic”.

In the case of “ferromagnetic” ballasts, these ballasts have high-inductance coils used to produce the surge which generates the illumination of the discharge lamp after a sudden removal of the power which limits the mains current to a level that is acceptable for the lamp. A thermal bimetal device, called a “starter”, causes the sudden removal of power and this illuminates the lamp. The primary purpose of the starter is to short-circuit the lamp through the electrodes in order to cause the electrode filaments to heat up due to the Joule effect. Then, when the filaments reach the necessary temperature, the bimetal is opened, and this causes a sudden removal of power. This generates a voltage spike at the ends of the coil, in accordance with the equation “V=−L*di/dt”, and this voltage spike is sufficient to produce a conduction of electrons between the two electrodes. This conduction has the effect, through ionization, of causing luminescent plasma in the lamp. After conduction, the impedance of the lamp drops. The current which runs through the ionized medium is then limited by the impedance of the coil inductor, in accordance with the equation Z=L. Cu where Cu corresponds to the mains frequency (the mains frequency can be 50 Hz or 60 Hz, for example, which correspond to a frequency of 314 rad/sec and 377 rad/sec respectively).

In the case of “electronic” ballasts, the discharge lamp is usually lit through the resonance of a series circuit consisting of a coil “L”, and a capacitor “C”, to create an overvoltage leading to conduction. An additional function may temporarily allow a current to flow through the electrode filaments to cause them to heat up in order to facilitate illumination and improve the lamp's life-span. In general, it is recognized that the voltage necessary for conduction between two electrodes of a discharge lamp decreases significantly when they are heated to a temperature of approximately 1000° C.

The “electronic” ballast conditions the line voltage and then distributes it to the discharge lamp's electrodes. The shape of the waveform running through the discharge lamp is usually a sinusoid with a frequency of some tens of thousands of Hertz. Electronic ballasts typically operate using alternating current: the current passes through the discharge lamp, passes into a capacitor and is then returned to complete the cycle. A low impedance coil, included in the circuit, dampens the overcurrent produced by the capacitor and limits the current at the operating frequency. In order to maintain the electrodes at a sufficiently-high temperature for the emission of electrons, some of the current running through the discharge lamp also runs through the filaments.

Electronic ballasts are designed to power one or more discharge lamps and may be adapted to various types of lamps.

Some currently-available electronic ballast are equipped with advanced features such as the ability to vary the light intensity (“gradation”) as controlled by a remote device via a wired connection based on protocols, some of which have been standardized by manufacturers such as DALI (Digital Addressable Lighting Interface). The operation of this feature requires the installation of a cable network between the electronic ballasts and the remote control devices.

The feature common to all these ballasts is that they are designed to be installed in lights having up to four discharge lamps; these lights are powered by the line voltage where the discharge lamps are connected to ballast (5) inside the lights through short electrical conductors.

The ballast technology results in energy losses which, when compared with the light source performance determines the lamp's luminous efficiency. The losses are relatively more significant in the case of ferromagnetic ballasts than electronic ballasts, however, they do occur in both cases and, therefore, in a general way, in all lights.

This is well known, as indicated in Patent Application Number US2006/0186834 “Multiple Lamp Ballast Control Circuit”, where ballast is used to power multiple lamps in parallel.

It is also indicated in U.S. Pat. No. 5,371,442, “Remote Ballast Circuit Assembly” describing a circuit comprising many types of ballast, each dedicated to a remote light located at a distance of several meters.

In light of the aforementioned, one of the aims of the invention is to provide a device to power and control discharge lamps and which makes it possible to at least partially solve the drawbacks mentioned above and, in particular, to provide a generator called a “Ballast Unit,” which can be placed at a remote distance from many discharge lamps while increasing their efficiency while still allowing their effective control.

In one configuration, an electronic device is proposed to control and power discharge lamps comprising:
A power signal generator; and
Various control units, each dedicated to at least one discharge lamp.

According to the general characteristics of the invention, the control units are connected in parallel to the aforementioned generator through a single power bus. There is a control unit for each of the lamps, an electronic circuit connected to the lamp and to the power bus and comprising a means of resonance which can resonate at the frequency of the generator's power signal to create an overvoltage at the terminals of the discharge lamp thus triggering its illumination.

In this way, it is possible to separate the lighting stage comprising a means of resonance and the power-signal generation stage discharge lamps. It is thus possible to power several discharge lamps with a common generator, also known as a “Ballast Unit”; these light sources can be moved tens of meters from the generator that powers them. The electrical signal power is not necessarily periodic. Instead, resonance can be obtained when it is subjected to an instantaneous power signal frequency corresponding to that of the resonance means for sufficient time (approximately 250 ms) to ignite the discharge lamp.

The power signal generation power consumption is thus combined into a single generator. The principle of resonating with the electric power signal to ignite the lamp facilitates a common generator with reduced consumption in comparison with the combined consumption of all the ballasts dedicated to the individual discharge lamps.

In addition, one to four discharge lamps can be connected to a single control unit which manages smart features in conjunction with the generator. The control unit, in combination with the discharge lamps to which it is connected, is called “Intelligent Lighting”.

By combining the option of powering multiple lamps with a single generator and the ability to power lamps located some distance from that generator, we have an electronic device which can adapt to a building's lighting constraints while ensuring minimal consumption, reducing maintenance costs and providing efficient control.

According to one configuration, each of the control units comprises a control module of electronic control circuits, and is capable of communicating with the generator communication module via a bidirectional channel. In this case, the generator is capable of controlling the electronic circuits of each of the control units by means of the said communication between the generator and the associated control module.

In particular, this control allows the generator to ignite, extinguish and/or preheat each of the control unit lamps to which it is connected.

According to one configuration, the bidirectional communication channel is realized by means of the modulation of carriers of the power bus.

As a result, there is no need for a communication bus in addition to a power bus since the power bus current can be used as a carrier to send information.

In yet another configuration, the bidirectional communication channel is implemented via a dedicated communication bus connected between the generator and each of the control units.

In another configuration, the generator is able to adjust the frequency, amplitude and/or shape of the power signal to communicate with a control module of a control unit.

The generator can then adjust the frequency of the electrical power signal to match the resonant frequency of the resonance means. After power is applied, the generator can adjust its amplitude and frequency so that the intensity of the light radiated by the discharge lamp (5) can be varied. Moreover, adjustment of the shape also modifies the amount of power sent to the control unit.

Since, in this case, the generator controls the electronic circuits as well as the power signal frequency; it can change the configuration of the electronic circuits by modulating the frequency of the electrical power signal it generates. The generator can thus configure one or more electronic circuits so that the means of resonance receives the power signal and produces overvoltage at the terminals of the discharge lamp at the same time that it generates a power signal at the resonant frequency.

According to another configuration, the resonance means comprises an inductive component and a capacitive component and the electronic circuit is configured to operate: in a normal configuration in which the inductive component is connected next to the discharge lamp and the capacitive component is not connected, and in an ignition configuration where the inductive component is connected next to the discharge lamp and the capacitive component is connected in parallel to the discharge lamp. The configurations can be selectively activated by the control module.

In this way the resonance means is simple to obtain and control. For example, the generator triggers the configuration for the ignition of several electronic circuits at the same time as it generates a power signal at the resonant frequency in order to ignite the discharge lamps associated with those electronic circuits.

The electronic circuit may comprise a second capacitive component connected between the inductive component and the discharge lamp. This second capacitive component can be short-circuited by a first means of communication from the electronic circuit to allow the inductive component to be connected directly to the discharge lamp or to be connected to the discharge lamp through the said, second capacitive component.

As a result, the second capacitive component can be short-circuited or left in-circuit. When it is not short-circuited, the second capacitive component reduces the impedance to obtain a higher current. This higher current allows the discharge lamp electrodes to be heated.

According to a further feature of this configuration, the electronic circuit comprises a third capacitive component connected between the two electrodes of the discharge lamp, the third capacitive component can be short-circuited by a second means of switching the electronic circuit to allow direct connection of the two electrodes to the discharge lamp or connection of the electrodes through the said third capacitive component.

When the third capacitive component is not short-circuited, a minimum current is maintained in the electrode's filaments. In a preheating configuration the third capacitive component is short-circuited and which much of the power current flows through the two electrodes to heat them via the Joule effect. When the electric power signal is used to enable ignition or maintenance of the discharge lamp lighting, it can connect the two electrodes via the third capacitive component to allow some current to pass through electrodes. Thus, a minimum temperature can be maintained.

According to yet another additional feature of this configuration, the electronic circuit comprises a third means of switching which is capable of isolating the said power bus electronic circuit.

A discharge lamp can thus be switched on or off from a control unit.

In one configuration, the control module can control the switching means of each of the electronic circuits.

In particular, the control module is able to control the switching means of each of the electronic circuits in response to the information sent from the generator's communication unit. In addition, the control module can also change the selected configuration (igniting or normal) based on this communication.

Control of the ignition or normal configurations and the switching means allows several electronic circuit configurations corresponding to all the different stages of discharge lamp operation (preheating, ignition, steady-state). These steps are controlled through the control module and can also be controlled via the generator communicating with the control module.

In one configuration, the control unit comprises of at least one sensor selected from a brightness sensor, a temperature sensor, a sensor of the light flux reflected by the illuminated by the discharge lamps of the control unit and sensor surfaces infrared presence, the control module is connected to at least one sensor.

The control module of each control unit is also equipped with a built-in programmable processing capacity and can measure data using the control unit's sensors.

In terms of sensors, there's a temperature sensor which reports the control unit temperature; an infrared sensor which gathers information on the number of people in the vicinity of the control unit and discharge lamps; a light sensor which gathers information about the ambient light and a sensor to measure the light flux reflected by the surfaces lit by the discharge lamps thus providing information about the luminous flux generated by the discharge lamps.

The control module can then activate different configurations and/or control the switching means based on sensor measurements.

The control module can then, for example, turn a discharge lamp on or off in accordance with the ambient brightness (based on data from the luminosity sensor) and/or the presence of people (based on data from the infrared sensor). It can also trigger a warm-up period depending on the temperature in controls unit equipped with discharge lamps. According to one feature of this configuration, the control unit is capable of sending the generator the measurements results obtained from at least one of these sensors.

The generator can thus perform effective remote control of the control units.

In another configuration, the generator includes a power-factor correction stage which produces a based DC voltage greater than 300 volts from the line voltage.

It is thus possible to adjust the power factor to improve performance while increasing power consumption from the mains.

In another feature of this configuration, the generator comprises a conversion stage with a transistor H-bridge for generating alternating voltage from the DC voltage of the said power signal.

The H-bridge incurs minimal loss while allowing efficient generation of an alternating signal. An alternating signal is a signal composed of positive cycles during which the amplitude of the signal is positive and negative cycles during which the signal has negative amplitude. In an alternating signal each positive cycle may be followed by a negative cycle. Such an alternating signal can be periodic if it consists of one cycle of a positive signal followed by one cycle of negative signal and is repeated for a significant period of time (a few tens of cycles).

With an alternating signal, the generator produces alternation; it is no longer necessary to equip the generator with any device to produce the reverse cycle or with a coil to absorb spikes.

In another configuration there is an assembly comprising a computer unit and at least one of the devices described above. This computer unit has processing, archiving, and communication facilities and the generator also has communication means configured to communicate with the computer unit.

There is thus provided a lighting system with several segments, each segment corresponding to one discharge lamp electronic control/ignition device as described above. The lighting system is controlled by a computer unit which can communicate with each generating devices. Through the generators, the computer unit can also, communicate with each control unit for of the each of the devices to, for example, turn a discharge lamp on or off or to collect a sensor measurement.

The present invention consists, therefore, of connecting a set of devices including a generator, to a computer unit using a dedicated connection, for example. The computer unit has the capacity to process and archive data and access the internet. Using internet access, it is possible to control the generator operation and thus the lighting devices, or segments, and also to collect quantitative and qualitative information concerning the installation's operational status. In a preferred configuration, the dedicated link provides communication via radio waves or via modulation of the power supply current.

Other features and advantages of the invention will become apparent through an examination of a detailed description of one, non-limiting, configuration of the invention and the appended drawings listed below:

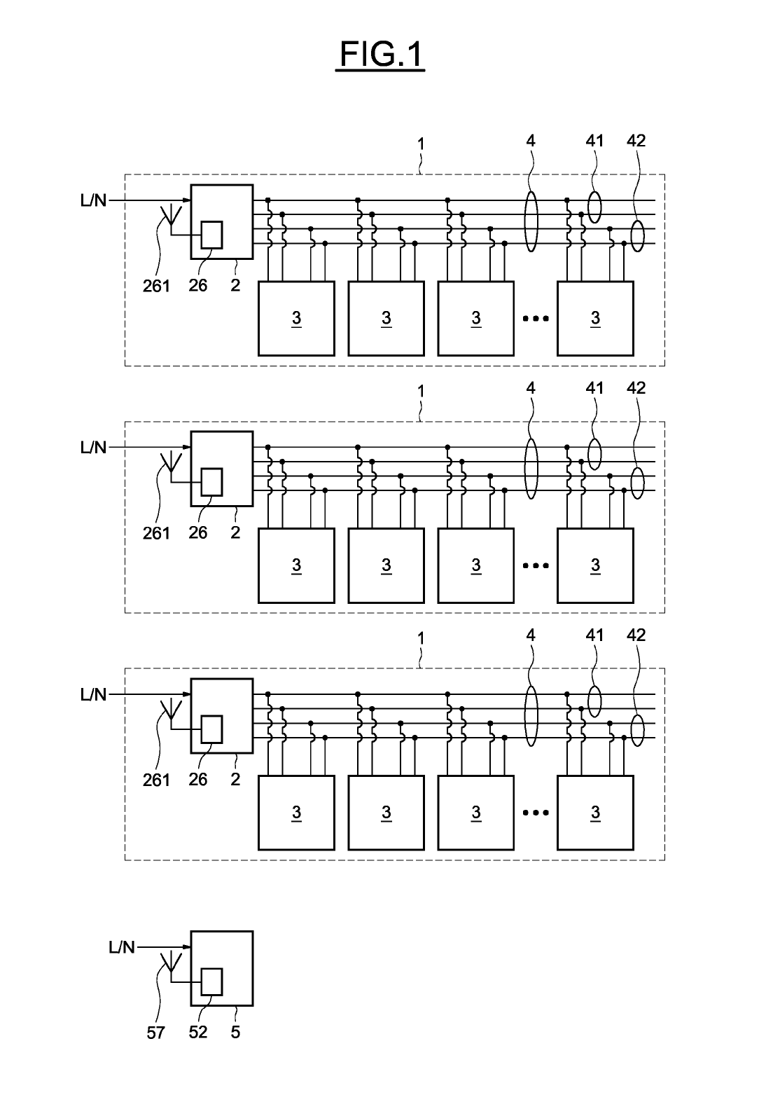

FIG. 1: illustrates a lighting assembly per the invention;

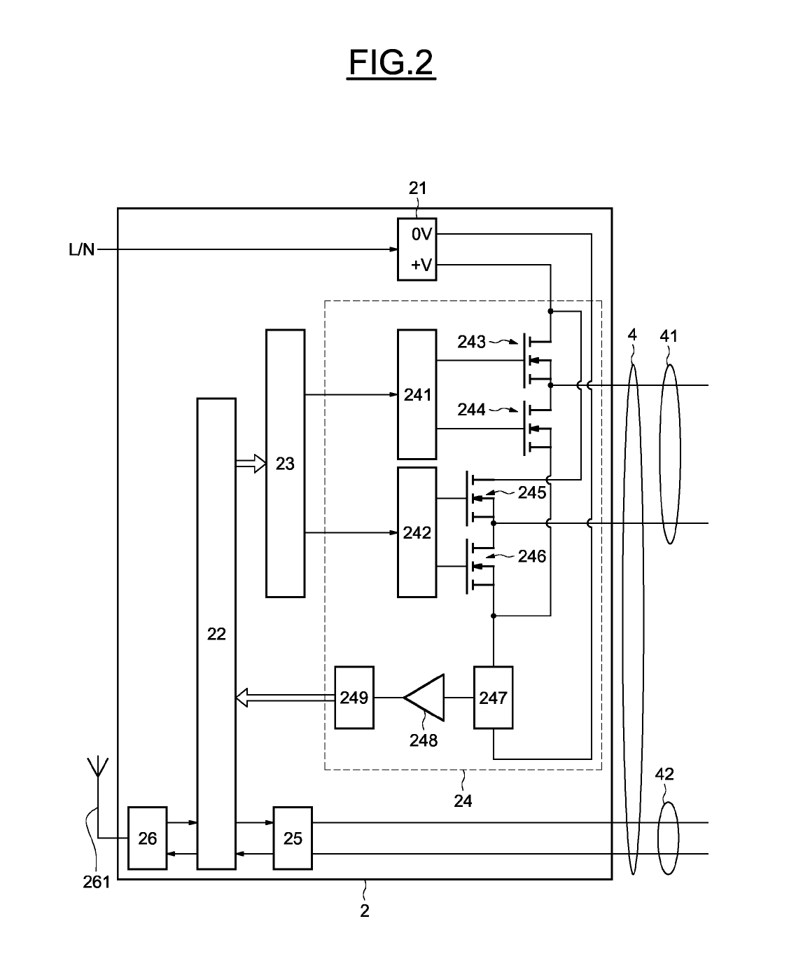

FIG. 2: illustrates the generator in more detail;

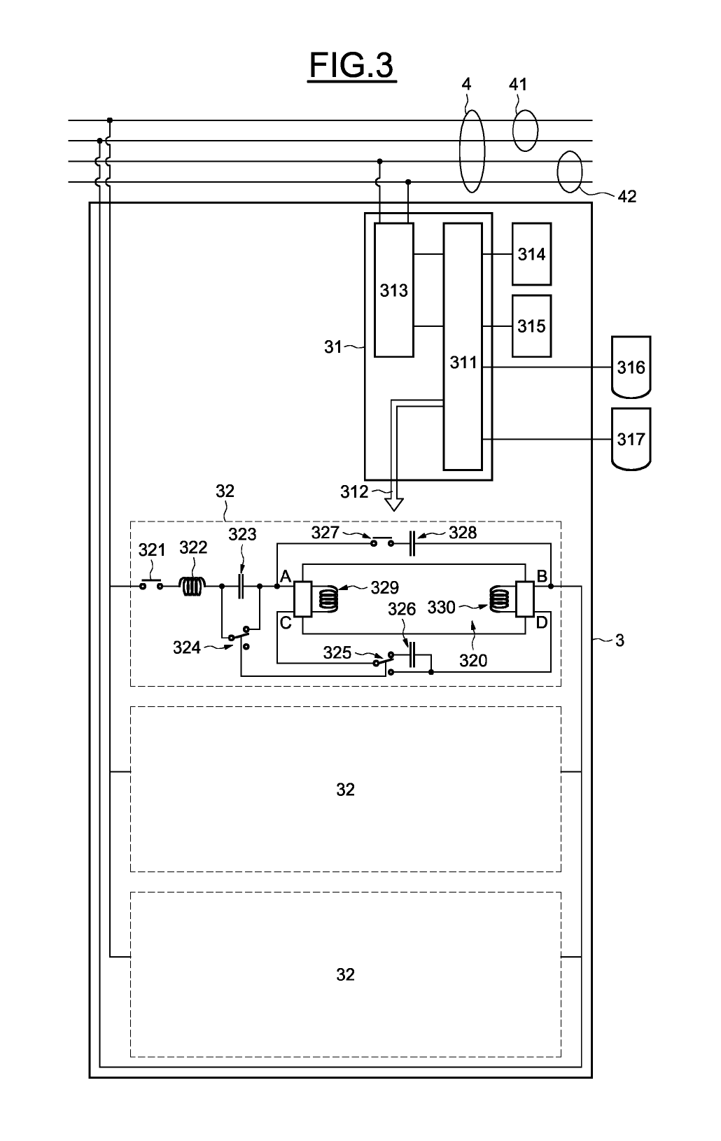

FIG. 3: illustrates the control unit in more detail, and

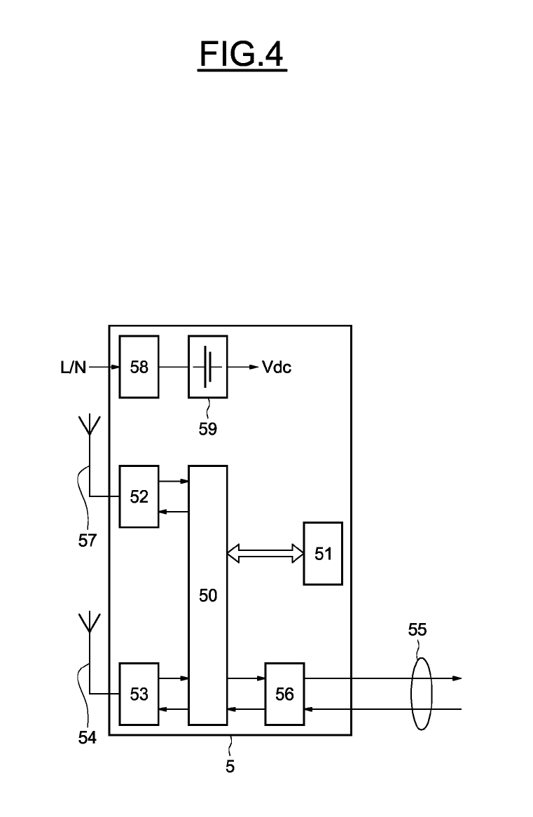

FIG. 4: illustrates the computer unit in more detail.

FIG. 1 illustrates a lighting system comprising a computer unit (5) and several electronic devices (1), where each electronic device is composed of electronic devices several control unit (3) and a generator (2). Each device (1) corresponds to one segment of the lighting system.

The generator (2) of each device is connected to control units (3) of the device via a bus (4). The control units are connected in parallel to the bus (4). The generator (2) supplies each control unit with an electric power signal via this bus. Each control unit (3) is connected to at least one discharge lamp.

Moreover, the generator (2) is capable of communicating via a communication module (26) and an antenna (261) with the computer unit (5) equipped with a communication module (52) and an antenna (57). For example, communication modules (26 and 52) are radio frequency modems which communicate via antennas (261 and 57) in the 2.4 GHz and 900 kHz frequency bands.

The computer unit (5) is connected to multiple electronic devices (1). The information and data sent by each of the generators (2) of the electronic devices (1) to the computer unit (5) concerning the operating time of the discharge lamps of device (1) and their energy consumption as well as an inventory of component failures relating to the concerned device.

The generator (2) is powered by an LIN mains voltage (L and N are acronyms that are well known to those skilled in the field and signify phase and neutral respectively) and generates an electric power signal on the bus (4). In addition, the generator (2) exchanges information through the bus (4) with the control units (3).

The bus (4) is a wire bus which, in one configuration, includes a power line (41), referred to as a “Power Line”, which carries the electric power signal and an electric communication line (42), referred to as a “Communication Line”, to carry the information exchanged between the generator (2) and the control units (3). In this configuration, the Communication Line (42) uses a serial transmission format with floating electric signals in accordance with the RS485 standard.

In another configuration, the electric communication line is not necessary and the power line (41) current is modulated is used to exchange information between the generator (2) and the control units (3).

FIG. 2 illustrates a generator (2) comprising the previously-described components (261) and (26), a power supply unit (21), a management unit (22), a power module (24), a unit (23) performing a logic function to the control unit (24) and an analogue to digital conversion unit (249).

Unit 21 is a power module with power-factor correction (or PFC, an acronym that is well known to those skilled in the field). Unit 21 supplies a DC voltage of between 300 and 400 Volts derived from the LIN AC line voltage.

Unit 22 is responsible for managing the operational process of the generator (2), it has a communication interface (25) connected to a Communication Line (42) and is also connected to the module (26). The microcontroller (22) also controls the dialog on the Communication Line (42) of the bus (4) and the dialog across the wireless connection (261). For example, unit 22 is a programmable microcontroller which manages the operation of generator 2 by means of a program.

Unit 24 consists of four fast-switching, low resistance transistors, in an H-bridge, (243, 244, 245 and 246). These transistors (243, 244, 245 and 246) are controlled by two circuits (241 and 242), and the control circuits are controlled by control signals produced by Module 23. Module 23 generates the H-bridge control signals under the control of unit 22. Unit 24 generates the power signal in the form of a succession of AC voltage levels, which could be separated by periods in which the voltage is zero.

Furthermore, unit 24 is equipped with a current transducer (247) whose signal is conditioned by an analog circuit (248) and then converted into a digital value by the analog-to-digital converter (249) to be sent to unit 22. Unit 22 will, therefore, control unit 23 in accordance with the conditioned, converted signal.

Unit 22 controls the shape of the electric power signal sent on the Power Line (41) of the bus (4).

In another configuration, the shape of the electric power signal is defined by a logic function of unit 23, and the control parameters of the aforementioned logic function are sent by the microcontroller (22) as control signals.

The shape of the electric power signal is important because it will affect the form-factor of the electric power signal and the power factor sent to the control units (3).

Unit 22's control signals facilitate modification of the frequency and form-factor of the electrical power signal. In a preferred version of the invention, unit 23 consists of a programmable logic device, a term well-known to those skilled in the field facilitating a greater degree of integration in comparison with a hard-wired logic function.

In a preferred version of the invention, the current passes through a Hall sensor (247) which enables isolation of the sensor's (247) measuring signal from the current passing through the H-bridge, in order to increase the immunity of the installation against electrical disturbances existing in the power signal transmitted along the Power Line (41).

FIG. 3 illustrates the structure of control unit (3) dedicated to at least one discharge lamp (320).

Control unit 3 includes, for each of the discharge lamps (320) the controls, an electronic circuit (32) connected to the aforementioned lamp (320). Control unit 3 also includes a control module (31) and internal or external sensors in the control unit. For example: an internal ambient light sensor (314) in control unit 3, an ambient temperature sensor (315) in control unit 3, an external, infrared, presence detector (317) in control unit 3 (a PIR-type sensor for example; an acronym well-known to those skilled in the field signifying passive infrared), or a sensor (not represented in FIG. 3) that detects the presence of a discharge lamp (320) in each of the electronic circuits (32), or even a luminous flux sensor (316) reflected from the surfaces lit by the discharge lamps of control unit 3, external to control unit 3 and which is movable (can be directed downwards for example).

In a preferred version of the invention, each of the control units (3) comprises two electric circuits (32) and two discharge lamps which are used for industrial or commercial lighting.

In another preferred version, control units (3) each comprise four electric circuits (32) and four discharge lamps to produce lights destined for the tertiary sector, such as luminous tiles integrated into false ceilings.

Of course, the number of electric circuits (32) and discharge lamps (320) are only examples. In the configuration illustrated in FIG. 3, the control unit (3) comprises three electric circuits (32) and three discharge lamps. The control unit's number (3) of the same electronic device (1) may each consist of a different number of discharge lamps (320) and electronic circuits than those of the other control units. The operation of the discharge lamps (320) each plugged into an electronic circuit (32) is managed by the control module (31).

The control module (31) comprises a programmable microcontroller (311) and has a communication interface (313) connecting it to the Communication Line (42). With this interface (313), the control module can exchange information with the generator (2). The control module (31) is also equipped with acquisition paths for internal and external sensors such as sensors 314-317. Included in the information exchanged with the generator (2), are the measurements made by the microcontroller (311) using the internal and external sensors. Furthermore, in a preferable configuration, the programmable microcontroller (311) is managed by management software in the microcontroller (311).

Module 31 may, be means of switching signals (312), control the electronic circuits (32) of the discharge lamps (320). Module 31 may, for example, be responsible for ensuring the appropriate connection to the power line (41) of the electrodes of each discharge lamp (320) in order to control the electrode filament pre-heating, as well as its on and off operation as described hereafter. To this end, the module (31) distributes switching signals (312) to the switches integrated into each electronic circuit (32).

The switching signals (312) are activated as a function, for example of the measurements made by the microcontroller (311) by means of sensors 314-317. Thus, the microcontroller (311) can manage the operation of the discharge lamps (320) and the electronic circuits (32) accordingly. For example, the module (31) can adapt the number of activated discharge lamps in accordance with the level of external light or the presence of people in the space lit by the discharge lamps to which the control unit is dedicated. The module 31 can control the luminous efficiency of the discharge lamps and their possible failures. The module (31) can also adapt the lighting mode to the ambient temperature or detect accidental overheating to ensure maintenance and safety.

The switching signals (312) are also activated in accordance with information exchanged with the generator (2). Thus, the microcontroller (311) may control the operation of the discharge lamps (320) and of the electronic circuits (32) by activation/de-activation through the generator. These orders can be directed towards one of the control units, some of the control units or even all of the control units of an electronic device (1). A communication protocol with different addresses for each of the control units and the generator can be used. Furthermore, activation or de-activation orders can involve all or some of the electronic circuits (32) of a control unit (3). Thus, data frames, with addresses, exchanged between the control units and the generator can provide information concerning the number of discharge lamps to be activated or de-activated.

The discharge lamp (320) is, for example, a florescent lamp or a lamp using at least one of the chemical compounds in the following list: neon, sodium vapor, mercury vapor or metal iodides. The discharge lamp (320) is equipped with a terminal “A”, a second terminal “B”, a third terminal “C”, and a fourth terminal “D”, terminals A and C connect to one electrode (329) and terminals Band D connect to a second electrode (330).

The electronic circuit (32), connected to the discharge lamp (320) has three capacitors:
a capacitor (323) whose left terminal is connected to the measurement circuit (32) with the power line (41) and whose right terminal is connected to terminal A of the discharge lamp (329).
a capacitor (326) whose left terminal is connected to terminal C of the discharge lamp (320) and whose right terminal connected to terminal D of the discharge lamp (320); and
a capacitor (328) whose left terminal is connected to terminal A of the discharge lamp (320) and whose right terminal is connected to terminal B of the discharge lamp (320).

The electronic circuit (32) also includes three contactors:
a single-pole contactor (321) whose left terminal is connected to the input of the electronic circuit (32) to the measurement connection (32) with the power line (41) and whose right terminal is connected to the capacitor (323). The contactor (321) controls the transmission of the electric power signal of the electronic circuit (32). It can be therefore opened to isolate the electronic circuit (32) and cause the lamp (320) to be switched on or off. It can also be closed to connect the electronic circuit (32) and cause the lamp (320) to be switched on or off.
a single-pole contactor (327) whose left terminal is connected to terminal A of the discharge lamp (320) whose right terminal connected to the capacitor (328). The contactor (327), therefore, controls the connection of the capacitor (328) placed in parallel to the discharge lamp. It can therefore be opened so that the capacitor (328) is connected in parallel with discharge lamp (320). It can also be closed so that the capacitor (328) is connected in parallel to the discharge lamp (320); and
a two-pole contactor (324/325) whose primary pole (324) is connected in parallel to the capacitor (323) and is capable of short-circuiting it and a secondary pole (325) connected in parallel to the capacitor (326) and is capable of short-circuiting it. The two-pole contactor (324/325) enables the capacitors (323 and 326) to be short-circuited. When the contactor is closed, the capacitor (323) is not short-circuited and the other capacitor (326) is short-circuited. When the two-pole contactor is open, capacitor 326 is not short-circuited and capacitance 323 is short-circuited.

Contactors (321, 327, and 324/325) are controlled by switch signals (312). In a preferred configuration, the contactors consist of electromagnetic relays. In another preferred configuration, they may consist of steady-state electronics.

The electronic circuit (32) also includes a coil (322) connected between the contactor (321) and the capacitor (323).

The electronic circuit (32) may, on one hand, be isolated from the power line (41) and may, on the other hand, be configured in the following configurations in accordance with the switch signals (312) generated by the programmable microcontroller (311):
a primary configuration in which the contactor (327) is open and the two-pole contactor (324/325) is open. In this case, the capacitor (323) is connected in series with the discharge lamp, a wire connects to the electrodes through terminal C and D of the discharge lamp and the capacitor (328) is not connected in parallel to the discharge lamp. Thus, the discharge is short-circuited across its electrodes which causes the electrode filaments to heat up due to the Joule effect;
a second configuration in which the capacitor (327) is open and the two-pole contactor (324/325) is closed. In this case, the capacitor (323) is short-circuited and the capacitor (326) is connected across terminals C and D of electrodes 329 and 330 of the discharge lamp. The capacitor 326 keeps the current flowing in the electrodes to continuously heat the electrode filaments; and
a third configuration in which the capacitor (327) is open and the two-pole contactor (324/325) is closed. In this case, the capacitor (323) is short-circuited and the capacitor (326) is connected across terminals C and D of electrodes 329 and 330 of the discharge lamp and the capacitor (328) is connected in parallel to the discharge lamp.

The primary configuration corresponds to the electrode warm-up stage.

The second configuration corresponds to a transient stage and to a stage where the discharge lamp energy is conserved.

The third configuration corresponds to a stage in which the discharge lamp is fully lit.

We will give an example, below, of the sequence of the various configurations and exchanges with the generator.

Firstly, an ignition order is sent by the generator (2) to at least one control unit (3). The control module (31) of the connected control unit determines whether electrode preheating is necessary. This is based on a temperature measurement obtained using sensor (315).

In the case where preheating is necessary, the control module places the concerned measurement circuits (32) in the primary configuration. The preheating period, during which the control module places the said measuring circuits (32) in the primary configuration, is calculated in such a way that the electrodes reach a temperature of 1000° C. and the duration depends on the temperature measurements performed via the sensor (315).

In configuration 1, current from the electric power signal flows into the discharge lamp (320) through a serial circuit consisting of the coil (322), the capacitor (323) and of each of the electrodes (329) and (330) of the discharge lamp (32).

Capacitor (323) is set up to produce a resonance effect with the coil (322) so as to reduce the overall impedance of the L-C circuit to generate an average current that is suitable for the electrodes (329 and 330) of the discharge lamp (320). Thus, the average current attained is sufficient to produce the desired warm-up of the electrode filaments (329) and (330) thus heating the filaments to a temperature of approximately 1000° C.

Configuration 1 is maintained throughout the preheating period determined by microcontroller (311) depending on the ambient temperature measured by the sensor (314). Configuration 2 is then activated followed by Configuration 3 which is maintained for a period of 250 ms.

In the case where preheating is not necessary, Configuration 2 is directly activated followed by Configuration 3 for a period of 250 ms.

In all cases, simultaneous to the activation of Configuration 3, the electric power signal, with a modified frequency, is sent over Power Line (41) of Wire Bus (4). The frequency is adjusted by the generator (2) in such that the power signal's frequency is close to the resonant frequency, Fr, of the circuit comprising the coil (322), of Inductance L and the capacitor (328) of capacitance, C. The resonant frequency can be determined using the equation

$$Fr = \frac{1}{2 π} \frac{1}{\sqrt{L \text{/} C}}$$

which is 49.5 kHz, where L=2.2 mH and c=4.7 nF.

Adjustment of the electric power signal frequency is, for example, based on a message sent from the control units (3) to the generator. It can also be automatically triggered by the generator itself which already has information concerning the temperature and preheat duration determined by the microcontroller (311) for the unites) which must be turned on.

The time during which the electric power signal frequency takes the resonant frequency value Fr is minimal (on the order of 250 ms). This prevents disturbance to the other control units that share the same power bus and are in Configuration 2 for ignition.

When the electronic circuit is placed into Configuration 3, the current from the electric power signal, at the resonant frequency, flows through a resonant serial circuit consisting of a coil (322) and a capacitor (328). This leads to a current surge such that the current, combined with the capacitor (328) impedance, produces a significant increase in voltage at the terminals of discharge lamps (320). This triggers its conduction and its ignition.

The microcontroller (311) verifies the lighting of the discharge lamp (32) by measuring the ambient luminosity via the light sensor (314) and, in the case of a failure, can launch the contactor (327) activation sequence to perform a specified number of attempts to ignite it.

Once ignition is attained, the microcontroller (31) places the electronic circuits (32) into Configuration 2 which allows for the ignition to be maintained. In this configuration, the capacitor (326) ensures that the minimum current is maintained in each filament (326) in the discharge lamp (320).

In a preferred configuration of the invention, the minimum current in the electrodes (329-330) maintains the electrode filaments at a temperature which ensures a plasmatic state inside the discharge lamp even when the electric power signal undergoes periods when the current is zero which could otherwise cause discharge lamp to turn off.

Information concerning the operational status of the electronic circuit can be sent through the Control Module (31) over the Communication Line (42) of the Wire Bus (4) to the generator. This results in an adjustment of the electric power signal to produce the scheduled lighting of the associated section. For example, the frequency of the electric power signal can be adjusted by the generator which facilitates variance in the impedance of coil 322 and, therefore, of the luminous intensity of discharge lamp (322).

At the request of the generator (2), in accordance with the microcontroller (22) program, the control module (31) can turn off the discharge lamp (320) by opening the contactor (321). In addition, during operation, and in accordance with management software in the microcontroller (311), the control module (31) is able to adapt the number of activated and de-activated electronic circuits (32) depending on, for example, the luminosity reflected by the surfaces lit by all the discharge lamps associated with the electronic circuits included in the control unit (3). This luminosity is, for example, measured by a movable light sensor (316) (movable downwards for example). Another feature: the control module (31) is able to activate or deactivate one or more electronic circuits (32) in accordance with the presence of persons detected by the infrared light sensor (317). FIG. 4 describes the architecture of the computer unit (5). Such a computer unit can manage the operation of a lighting system comprising multiple electronic devices (1), each of which corresponds to one segment of the lighting system.

The computer unit (5) consists of a non-volatile memory (51) and a microcontroller (50) which has a data archive capacity in its memory (51). The microcontroller (50) is powered by a DC voltage (VDC) produced from the LIN line voltage through a conversion module and voltage regulator (58) equipped with a battery buffer which ensures power in case of a line voltage dropout. The computer unit (5) is, thereby, equipped with a programmable data archiving capacity.

The computer unit (5) also comprises a wireless communication interface module (52) and an antenna (57). The computer unit (5) can, therefore, communicate with the control units (22) of each generator (2). In another configuration, the computer unit (5) can control the power signal and the orders sent by the generators (2).

The computer unit (5) also includes an internet access interface (53) and a wireless internet access module (54) (3G+ network, for example). The processing unit (5) is, thus, equipped with a wireless communication channel that facilitates the connection to an external processor via the internet.

The computer unit also consists of a processor connection interface (56) and a USB or RS232 serial connection (55). Thus, the computer unit (5) facilitates direct connection to an external processor.

Communication between an external microprocessor and the computer unit (5), either, by the wired connection (55), or by the wireless connection (54) through the internet is provided to facilitate remote control of the lighting system operation through commands and controls acting on the control units (31) which ensure the operation of the discharge lamps. These commands are sent via the generators (2) and the Communication Line 42 of Bus 4.

Communication between the external microprocessor and the computer unit (5) also facilitates collection, archiving and processing of the information and data related to the operation of each electronic circuit (32), this information and data being produced by each control module (31) and sent to the generator (2) of each segment (1) by Communication Line (42) of the Bus (4), to be transmitted to the computer unit (5) via the wireless communication network between the generators (2) and the computer unit (5).

In this way, within the lighting system comprising multiple electronic devices (1), where each of these devices corresponds to one segment of this lighting system, the computer unit (5) is the access point to the internet, facilitating control of the installation and collection of operational and performance data. This data can also be stored in the memory (51) of the computer unit (5) in such a way as to constitute a non-volatile, local archive. Access to the functionalities of the computer unit (5) can be also performed by means of the cable connection (55) which ensures redundancy in the case of a failure of the internet connection.

Furthermore, in the case of a communication failure between a generator (2) and the computer unit (5) at the site, two operational modes are available, where each one corresponds to a particular configuration. These operational modes ensure lighting via the device (1) regardless of the status of the wireless connection (57).

According to a first configuration, activation of the control units (3) of the segment or device (1) can be ensured via a command sent via the voltage of the LIN mains sector powering the generator (2).

According to another configuration, the generator (2), which does not have more than one reliable communication link with the computer unit (5) of the site, automatically controls the control units (3) which comprise its segment (1), either by continuing the operation at the moment of the communication failure, or by activating the lighting of the control units (3) comprising its segment (1), and their operation in an elementary mode determined by its program.

According to these two configurations, information concerning this failure, as well as the segment's operational data are then saved in the microcontroller (22) of the generator (2) in order to be sent to the computer unit (5) when the communication is restored.

In another preferential configuration of the invention, the generator (2) can be paired with a second identical generator in order to ensure redundancy in the case of a failure. In such a configuration, activation of one or the other of the two generators is controlled by the site's computer unit (5), via the wireless communication (57). Information concerning the failure can be sent over the internet (54) for maintenance planning purposes.

1-15. (canceled)

16. A control device for controlling electronics and power supply of discharge lamps, said device comprising:
a generator configured to generate at least one power signal; and
a plurality of control blocks each dedicated to controlling at least one discharge lamp;
wherein said control blocks are each connected in parallel to said generator by a single power bus, and in that each of said control blocks includes for each of said discharge lamps to which said block is dedicated, an electronic circuit is connected to said discharge lamp and said power bus, said electronic circuit comprising resonant means configured to resonate at a frequency of said power signal from said generator so as to create a voltage across said discharge lamp and trigger ignition of said discharge lamp.

17. The control device as claimed in claim 16, wherein each of said control blocks comprises a control module of said electronic circuit configured to communicate by way of a bidirectional communication channel with a communication module of said generator, said generator being configured to control said electronic circuit of each of said control blocks by said communication between said generator and said control module.

18. The control device as claimed in claim 17, wherein said bidirectional communication channel is achieved by a modulation of carriers of said power bus.

19. The control device as claimed in claim 17, wherein said bidirectional communication channel is a communication bus dedicated connecting said generator to each of said control blocks.

20. The control device as claimed in claim 17, wherein said generator is configured to adjust at least one selected from the group consisting of frequency, amplitude, and shape depending on a communication power signal with said control module of at least one of said control blocks.

21. The control device as claimed in claim 20, wherein said resonance means comprises an inductive component and a capacitive component and said electronic circuit is configured to operate according to one of a normal configuration and an ignition configuration, said normal configuration is in which said inductive component is connected in series with said discharge lamp and said capacitive component is not connected, said ignition configuration is wherein said inductive component is connected in series with said discharge lamp and said capacitive component is connected in parallel to said discharge lamp, patterns being selectively activated by said control module.

22. The control device as claimed in claim 21, wherein said electronic circuit comprises a second capacitive component connected between said inductive component and said discharge lamp, said second capacitive component being bypassed by a first switching means of said electronic circuit to allow direct connection of said inductive component on said discharge lamp or a connection of said inductive component on said discharge lamp through said second capacitive component.

23. The control device as claimed in claim 22, wherein said electronic circuit comprises a third capacitive component connected between two electrodes of said discharge lamp, said third capacitive component is configured to be short-circuited by a second switching means of said electronic circuit to allow direct connection of said two electrodes of said discharge lamp or a connection of said two electrodes through said third capacitive component.

24. The control device as claimed in claim 23, wherein said electronic circuit comprises a third switching means configured to isolate said electronic circuit of said power bus.

25. The control device as claimed in claim 24, wherein said control module is configured to control said first, second and third switching means of each of said electronic circuits.

26. The control device as claimed in claim 25, wherein said control blocks each comprises at least one sensor selected from the group consisting of a light sensor, a temperature sensor, a sensor lumen reflected by a surface illuminated by said discharge lamp of said control block, and an infrared motion detector, said control module being connected to said at least one sensor.

27. The control device as claimed in claim 26, wherein said control module is configured to communicate results of measurements made by said at least one sensor to said generator.

28. The control device as claimed in claim 16, wherein said generator comprises a correction stage of a power factor producing from a mains voltage, a DC voltage greater than 300 volts.

29. The control device as claimed in claim 28, wherein said generator comprises a conversion stage having a H-bridge transistors for generating from said DC voltage said power signal, said power signal is AC.

30. The control device as claimed in claim 16, wherein said resonance means of said electronic circuit is a coil connected between a switch, and a capacitive component, said switch is configured to isolate said electronic circuit of said power bus, said capacitive component is connected between an inductive component and said discharge lamp.

31. The control device as claimed in claim 16, wherein said generator comprises a mains supply power factor corrector, and a microcontroller in communication with a communication interface that is connected to a communication bus of a bidirectional communication channel.

32. The control device as claimed in claim 31, wherein said generator further comprises four transistors controlled by two control circuits, said control circuits being controlled by control signals produced by a Programmable Logic Device, said Programmable Logic Device is configured to generate said control signals under a control of said microcontroller, said transistors and said control circuits are configured to generate said power signal in a form of a succession of voltage levels+V of alternating polarity, separated by periods when said voltage levels is zero.

33. The control device as claimed in claim 32, wherein said generator further comprises a current sensor, an analog circuit in communication with said current sensor, and an analog-to-digital converter in communication with said analog circuit, said current sensor is configured to produce a measurement signal that is conditioned by said analog circuit, said measurement signal conditioned from said analog circuit is converted into a digital value by said analog-to-digital converter to be acquired by said microcontroller, said microcontroller will then control said Programmable Logic Device as a function of said measurement signal conditioned and converted.

34. A discharge lamp control system comprising:
a central computer in communication with a processor, a storage device and a communication devise;
a generator to at least one power signal, said generator including a communication means configured to communicate with said communication device of said central computer; and
a plurality of control blocks each dedicated to a control of at least one discharge lamp;
wherein said control blocks are each connected in parallel to said generator by a single power bus, and in that each of said control blocks includes for each of said discharge lamps to which said block is dedicated, an electronic circuit is connected to said discharge lamp and said power bus, said electronic circuit comprising resonant means configured to resonate at a frequency of said power signal from said generator so as to create a voltage across said discharge lamp and trigger ignition of said discharge lamp.
